(19) United States
(12) Patent Application Publication
(10) Pub. No.: US 2026/0270573 A1
(43) Pub. Date: Sep. 10, 2026

(54) PIXEL CIRCUIT WITH PHOTORECEPTOR CIRCUIT AND SOLID-STATE IMAGING DEVICE FOR EVENT DETECTION

(71) Applicant: Sony Semiconductor Solutions Corporation, Kanagawa (JP)

(72) Inventors: Raphael BERNER, Stuttgart (DE); Massimo ZANNONI, Stuttgart (DE); Christian Peter BRÄNDLI, Aargau (CH)

(73) Assignee: Sony Semiconductor Solutions Corporation, Kanagawa (JP)

(21) Appl. No.: 19/165,159

(22) PCT Filed: Mar. 13, 2024
(86) PCT No.: PCT/EP2024/056627

§ 371 Date: Sep. 15, 2025

(30) Foreign Application Priority Data
Mar. 30, 2023 (EP) 23165510.1

(51) Int. Cl. H04N 25/47; H04N 25/77

(52) U.S. Cl. CPC H04N 25/47; H04N 25/77

(57) ABSTRACT

A pixel circuit includes a photoelectric conversion element configured to convert incident radiation into a photoreceptor current IPC. A photoreceptor circuit converts the photoreceptor current IPC into a photoreceptor voltage VPR in a conversion period, wherein an operating point of the photoreceptor circuit is set in an initialization period in response to an active initialization signal INIT. An event detection circuit outputs a digital event signal in response to a predefined change of the photoreceptor voltage VPR.

The present disclosure relates to a pixel circuit including a photoreceptor circuit for event detection, and to a solid-state imaging device. More particularly, the present disclosure relates to the field of event detection sensors that respond to predefined changes in light intensity, such as dynamic vision sensors (DVS) and event-based vision sensors (EVS).

### BACKGROUND

Event detection image sensors like DVS and EVS deliver information about the position of predefined changes in the imaged scene. Unlike image sensors that transfer large amounts of image information in frames, transfer of information about pixels that do not change can be omitted, resulting in a sort of in-pixel data compression. The in-pixel data compression removes data redundancy and facilitates high temporal resolution, low latency, low power consumption, high dynamic range, and little motion blur.

Pixel circuits for DVS and EVS include a photoreceptor module and an event detection circuit. The photoreceptor module continuously converts incoming radiation into a photoreceptor voltage, wherein a magnitude of the photoreceptor voltage increases with the intensity of the incident radiation. The event detection circuit compares an instantaneous magnitude of the photoreceptor voltage with a previous instance of the photoreceptor voltage. The event detection circuit outputs ON events if an increase of the photoreceptor voltage exceeds a predefined step-up value and OFF events if a decrease of the photoreceptor voltage exceeds a predefined step-down value.

### SUMMARY

Although EVS and DVS pixels realize high-speed data output and low latency by limiting the output data to changes in the radiation intensity detected by each pixel, some applications require, or at least would benefit from, even lower latency. Such applications may include structured light applications for distance measurements and 3D image construction, by way of example.

The present technology has been made in view of this situation and aims to improve the performance of pixel circuits for event detection.

In this regard, the present disclosure relates to a pixel circuit that includes a photoelectric conversion element that converts incident radiation into a photoreceptor current. A photoreceptor circuit converts the photoreceptor current into a photoreceptor voltage in a conversion period, wherein an operating point of the photoreceptor circuit is set in an initialization period in response to an active initialization signal. An event detection circuit outputs a digital event signal in response to a predefined change of the photoreceptor voltage.

By properly setting the operating point, for example, by using a closed loop feedback the photoreceptor circuit can operate in an open loop with high gain and band-pass behavior during the conversion period. The high gain conversion characteristic can be combined with low step-up and step-down thresholds for event detection to achieve low latency. Lower latency allows for higher scan speed in structured light applications.

The described embodiments, together with further advantages, will be best understood by reference to the following detailed description taken in conjunction with the accompanying drawings.

### BRIEF DESCRIPTION OF THE DRAWINGS

FIG. 1 is a schematic diagram illustrating a configuration example of an imaging apparatus as an electronic device including a solid-state imaging device with pixel circuits according to the embodiments.

FIG. 2 is a simplified block diagram illustrating a configuration example of a solid-state imaging device with low latency pixel circuits in accordance with an embodiment related to a synchronous readout.

FIG. 3 is a simplified block diagram illustrating a configuration example of a solid-state imaging device with low latency pixel circuits in accordance with an embodiment related to an asynchronous, event-triggered readout.

FIG. 4 is a schematic diagram illustrating an embodiment in which a solid-state imaging device has a two-layer structure in a stacked CIS configuration.

FIG. 5 is a simplified block diagram illustrating a configuration example of a pixel circuit with an initiable photoreceptor circuit for low latency in accordance with an embodiment.

FIG. 6 is a simplified circuit diagram illustrating a configuration example of a pixel circuit with an initiable photoreceptor circuit based on a logarithmic amplifier circuit in accordance with an embodiment.

FIG. 7 is a circuit diagram illustrating a configuration example of a pixel circuit with a photoreceptor circuit initiable by a signal switching circuit including an nFET and a pFET electrically connected in parallel in accordance with an embodiment.

FIG. 8 is a circuit diagram illustrating a configuration example of a pixel circuit with a photoreceptor circuit initiable by a signal switching circuit including an nFET and a dummy FET electrically connected in series in accordance with an embodiment.

FIG. 9 is a circuit diagram illustrating a configuration example of a pixel circuit with a photoreceptor circuit initiable by a signal switching circuit including an nFET and two dummy FETs electrically connected in series in accordance with an embodiment.

FIG. 10 is a simplified circuit diagram illustrating a configuration example of a pixel circuit with an initiable photoreceptor circuit including a common source amplifier circuit and an event detection circuit 150 in accordance with an embodiment.

FIG. 11 is a simplified time diagram of signals for controlling the pixel circuit of FIG. 10 in accordance with an embodiment.

FIG. 12 is a simplified circuit diagram illustrating a configuration example of a pixel circuit with an initiable photoreceptor circuit including a common source amplifier circuit with a cascode transistor in accordance with an embodiment.

FIG. 13 is a circuit diagram illustrating a configuration example of a pixel circuit with an initiable photoreceptor circuit including a multi-stage common source amplifier circuit in accordance with an embodiment.

FIG. 14 is a circuit diagram illustrating a configuration example of a pixel circuit with an initiable photoreceptor circuit including a multi-stage common source amplifier circuit in accordance with another embodiment.

FIG. 15 is a simplified circuit diagram illustrating a configuration example of a pixel circuit with an initiable photoreceptor circuit and an in-pixel logic circuit for controlling the initiable photoreceptor circuit in accordance with an embodiment.

FIG. 16 is a simplified time diagram of internal signals and output signals of the pixel circuit of FIG. 15 in response to an increase in incident radiation in accordance with an embodiment.

FIG. 17 is a circuit diagram of a portion of a pixel circuit in accordance with an embodiment and illustrates a distribution of elements of the pixel circuit on two different semiconductor chips in accordance with an embodiment providing two through-contact vias per pixel circuit.

FIG. 18 is a circuit diagram of a portion of a pixel circuit in accordance with an embodiment and illustrates a distribution of elements of the pixel circuit on two different semiconductor chips in accordance with an embodiment providing three through-contact vias per pixel circuit.

FIG. 19 is a circuit diagram of a portion of a pixel circuit in accordance with an embodiment and illustrates a distribution of elements of the pixel circuit on two different semiconductor chips in accordance with another embodiment providing three through-contact vias per pixel circuit.

FIG. 20 is a block diagram depicting an example of a schematic configuration of a vehicle control system.

FIG. 21 is a diagram of assistance in explaining an example of installation positions of an outside-vehicle information detecting section and an imaging section of the vehicle control system of FIG. 20.

### DETAILED DESCRIPTION

Embodiments for implementing techniques of the present disclosure will be described below in detail using the drawings. The techniques of the present disclosure are not limited to the described embodiments, and various numerical values and the like in the embodiments are illustrative only. The same elements and elements with the same functions are denoted by the same reference signs. Duplicate descriptions are omitted.

Connected electronic elements may be electrically connected through a direct and permanent low-resistive connection, e.g., through a conductive line. The terms “connected”, “electrically connected” and “signal-connected” may also include a connection through other electronic elements provided and suitable for permanent and/or temporary signal transmission and/or transmission of energy. For example, electronic elements may be electrically connected or signal-connected through resistors, capacitors, and electronic switches such as transistors or transistor circuits, e.g., field effect transistors (FETs), transmission gates, and others.

The load path of a transistor is the controlled current path through a transistor. For example, a voltage applied to the gate of a FET controls the current flow through the load path (controlled path) between source and drain of the FET by field effect. If it is described that a transistor is connected in series with another element or is connected in parallel with another element, then such information refers to the load path of the transistor.

A digital signal alternates between at least one active level and at least one passive level. A digital signal having an active level is active. A digital signal having an inactive level is inactive. The active level can be a digital high level or a digital low level. The inactive level can be a digital low level or a digital high level.

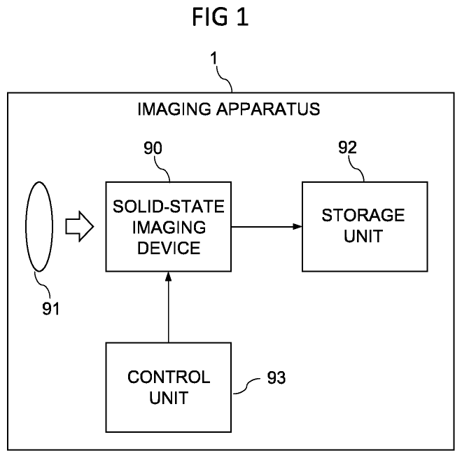

In FIG. 1, an imaging apparatus 1 includes an optical system 91, a solid-state imaging device 90, a storage unit 92, and a control unit 93. The optical system 91 includes one or more lenses and various mechanisms such as an autofocus mechanism and a diaphragm mechanism, and guides light from an object to a light receiving surface of the solid-state imaging device 90.

The solid-state imaging device 90 includes an image sensor having a plurality of pixel circuits. Each pixel circuit converts incident radiation into electric signals by photoelectric conversion, and outputs event data based on the electric signals. The solid-state imaging device 90 further includes a signal processing unit that performs predetermined signal processing on the event data output from the pixel circuits and outputs processed event data.

The storage unit 92 stores the event data output from the solid-state imaging device 90 in a storage medium. The storage medium may include a volatile storage medium and/or non-volatile storage medium. The non-volatile storage medium may be or include a flash memory or a hard disk drive. The non-volatile storage medium may be or include a dynamic random access memory (DRAM).

The control unit 93 controls the solid-state imaging device 90, such that the solid-state imaging device 90 performs an imaging operation. The imaging operation includes detecting changes in the scene and outputting event data including information about changes in the appearance of the object or in the scene.

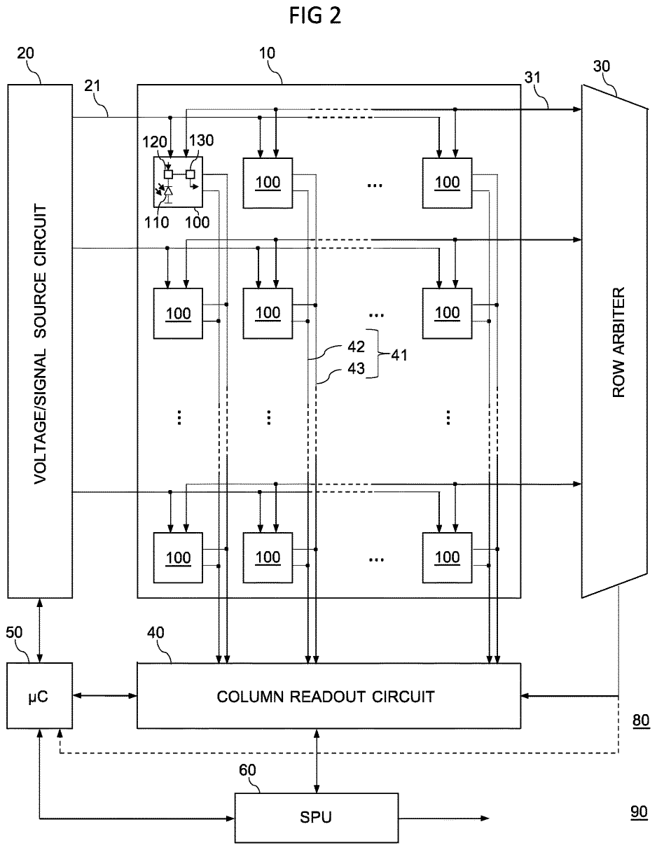

FIG. 2 is a block diagram illustrating a configuration example of a solid-state imaging device 90 for synchronous readout and with pixel circuits 100 according to the present embodiments. The solid-state imaging device 90 includes an image sensor 80 and a signal processing unit 60. The image sensor 80 includes a pixel array 10, a voltage/signal source circuit 20, a row arbiter 30, and a sensor control circuit 50.

In the pixel array 10, a plurality of pixel circuits 100 is arrayed in a two-dimensional matrix in pixel rows and pixel columns. For simplicity, pixel circuits 100 belonging to the same pixel row are arranged along a horizontal line in FIG. 2, and pixel circuits 100 belonging to the same pixel column are arranged along a vertical line in FIG. 2.

Each pixel circuit 100 includes a photoelectric conversion element 110, a photoreceptor circuit 120, an event detection circuit 130, and a in-pixel logic circuit. The photoelectric conversion element 110 and the photoreceptor circuit 120 form a photoreceptor module that continuously converts incident radiation into a photoreceptor voltage, wherein the photoelectric conversion element 110 continuously converts the incident radiation into a photodetector current and the photoreceptor circuit 120 converts the photoreceptor current into a photoreceptor voltage. A magnitude of the photoreceptor voltage increases with increasing intensity of the incident radiation. The event detection circuit 130 detects events based on the magnitude of changes in the photoreceptor voltage. The photoreceptor circuit 120 may be initiable in response to an initialization signal.

The event detection circuit includes a differencing capacitor that receives the photoreceptor voltage at a first electrode. A comparator circuit compares a resettable voltage at a second electrode of the differencing capacitor with a threshold voltage.

The event detection circuit is resettable to an initial state by temporarily turning on a reset switch that resets the resettable voltage during an autozeroing in an autozero period. In a detection period following the autozero period, the resettable voltage follows changes of the photoreceptor voltage. The in-pixel logic circuit controls the output of event data from the pixel circuit 100 and the autozeroing of the event detection circuit. In addition, the in-pixel logic circuit may control initialization of the photoreceptor circuit 120.

The event data indicates that the intensity of incident radiation has decreased by more than a certain value compared to the magnitude at the previous event readout (“OFF event”). Alternatively, the event data indicates that the intensity of incident radiation has increased by more than a certain value compared to the previous event readout (“ON event”).

An event data bus 41 may include a common data line for transmitting the ON events and the OFF events by different signal levels or in a time multiplex scheme. In the illustrated embodiment, the event data bus 41 includes a first data line 42 for transmitting the ON events and a second data line 43 for transmitting the OFF events. For transmitting an ON event, an ON event signal transmitted on the first data line 42 has an active level. For transmitting an OFF event, an OFF event signal transmitted on the second data line 43 has an active level.

The column readout circuit 40 receives the event data from all pixel circuits 100 of the selected pixel group via the event data bus 41, and the group address(es) of the selected pixel group from which the received event data originates. From the group address and identifiers of the event data buses 41 transmitting event data, the column readout circuit 40 may compile a digital address event representation AER for each event. The AER includes the group address, a column address derived from the identifiers of the event data busses transmitting events, the event data, and, if applicable, a time stamp. The column readout circuit 40 outputs the AERs to the signal processing unit 60.

The voltage/signal source circuit 20 generates one or more fixed or in a predefined way changing analog voltages and/or digital control signals and outputs the analog voltages and/or digital control signals to groups of pixel circuits 100 through control signal lines 21. A group of pixel circuits 100 can include some or all pixel circuits 100 of a pixel row, the pixel circuits 100 of more than one pixel row, or all pixel circuits 100 of the pixel array 10.

FIG. 2 concerns an image sensor 80 for synchronous readout. Group control buses 31 connect the pixel circuits 100 with the row arbiter 30. Each group control bus 31 connects the pixel circuits 100 of one group with the row arbiter 30. Each group control bus 31 may include a group request line for transmitting request signals from the pixel circuits 100 of the pixel group to the row arbiter 30, and a group acknowledgement line for transmitting a group acknowledgement signal from the row arbiter 30 to the pixel circuits 100 of a group of pixel circuits 100 to be selected.

For each pixel circuit 100 detecting an event, the in-pixel logic circuit of the concerned pixel circuit 100 outputs an active request to the row arbiter 30 on the group request line. For transmitting the request, a request signal transmitted on the group request line has an active level.

The row arbiter 30 performs arbitration among the pending active requests output from the pixel circuits 100 of the pixel array 10. The row arbiter 30 selects a request received from a specific group of pixel circuits 100, acknowledges the request by outputting a confirmation on the group control bus 31, and transmits the corresponding group address (e.g., row number) to the column readout circuit 40. For transmitting the confirmation, the row arbiter 30 outputs an active group acknowledgement signal on the group acknowledgement line. The active group acknowledgement signal selects a group of pixel circuits 100.

In response to the confirmation, all selected pixel circuits 100 in which an event has been detected, apply the event data on the respective event data bus 41. Each event data bus 41 may be connected to some or all pixel circuits 100 of a same pixel column, or to all pixel circuits 100 of more than one pixel column.

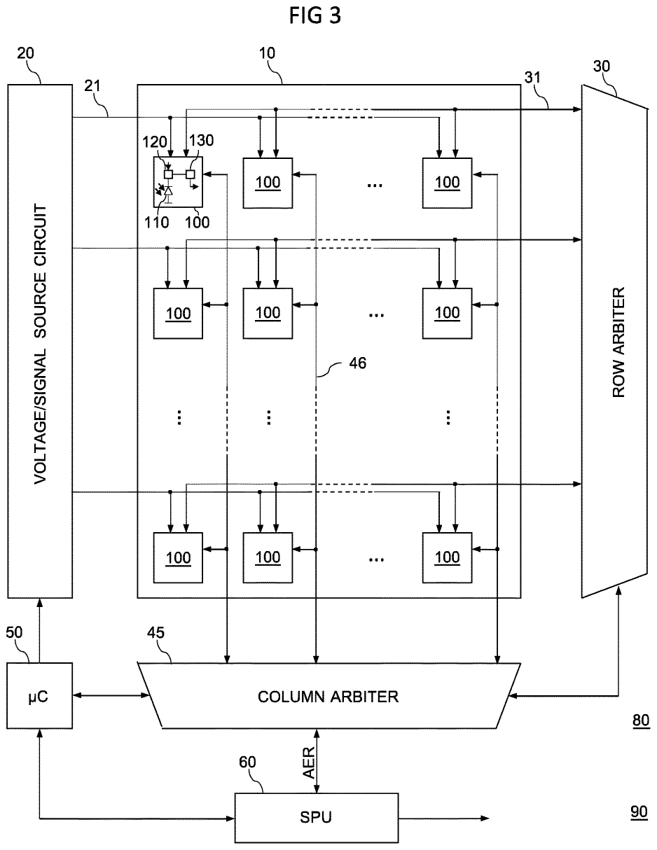

The solid stage imaging device 90 in FIG. 3 is configured for asynchronous, event-triggered readout. Each pixel circuit 100 that detects an event indicates the event by outputting a group request signal on a group request line of a group control bus 31 to the row arbiter 30 and a column request signal on a column interface bus 46 to a column arbiter 45. In the row arbiter 30 and the column arbiter 45, the request signals trigger the compilation of event information. The event information includes a pixel address identifying the position of the pixel circuit 100 in the pixel array 10, the sign of the change in light intensity, and a time stamp. The row arbiter 30 and the column arbiter 45 output the event information to the signal processing unit 60 and confirm to the pixel circuit 100 reception of the event. Upon receiving the confirmation, the event in the pixel circuit 100 is cleared and the pixel circuit 100 is reset.

The sensor control circuit 50 of FIG. 2 and FIG. 3 controls a timing of changing analog voltage signals in the voltage/signal source circuit 20, a selection of voltage levels output by the voltage/signal source circuit 20 according to internal states and/or user settings, and/or a communication between the column readout circuit 40 and the signal processing unit 60 of FIG. 2 or between the row arbiter 30, the column arbiter 45 and the signal processing unit 60 of FIG. 3 as indicated by the dashed line.

The signal processing unit 60 receives the AERs. The signal processing unit 60 may execute signal processing such as image recognition processing based on the received AERs. The signal processing unit 60 may output processed image data to the storage unit 92 of FIG. 1 and/or through a wired or wireless electronic interface.

Solid-state imaging devices 90 as described with reference to FIG. 2 and FIG. 3 can be provided as, for example, stacked contact image sensors (CIS) formed by stacking a plurality of semiconductor chips. As an example, the solid-state imaging device 90 a can be formed by a two-layer structure in which semiconductor chips are stacked in two layers.

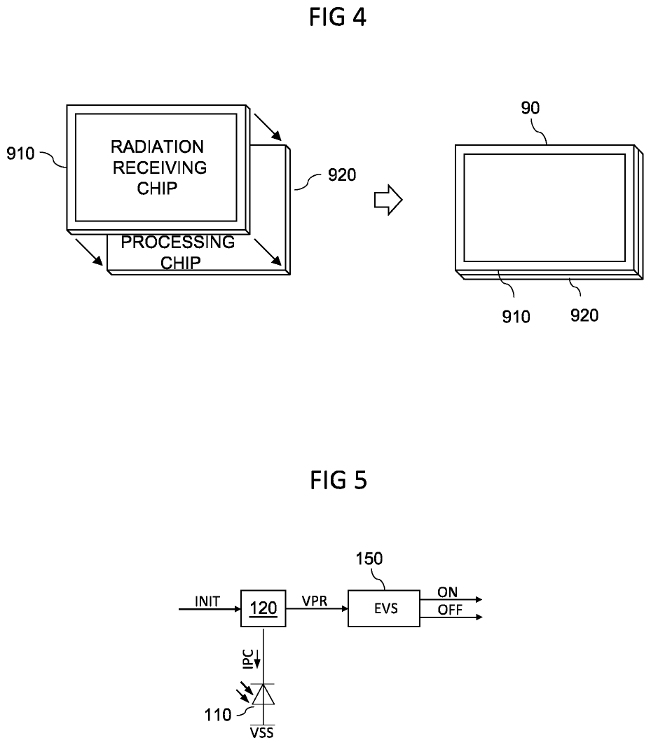

FIG. 4 is a diagram illustrating an example in which the solid-state imaging device 90 of FIG. 2 or FIG. 3 is formed by a stacked CIS having a two-layer structure with a radiation receiving chip 910 and a processing chip 920. The radiation receiving chip 910 includes at least the photoelectric conversion element. For example, the radiation receiving chip 910 may include only the photoelectric conversion element, or a part of the photoreceptor circuit including the photoelectric conversion element and one or more transistors, or the complete photoreceptor circuit, or the complete photoreceptor circuit and further elements of the pixel circuits. The processing chip 920 includes the further elements of the pixel circuits 100, e.g., the event detection circuit and the in-pixel logic circuit. As shown on the right side of FIG. 4, the solid-state imaging device 90 is formed as a one-piece sensor by bonding the radiation receiving chip 910 and the processing chip 920 together, wherein contact pads on the radiation receiving chip 910 are bonded to corresponding contact pads on the processing chip 920. The bonding electrically connects the contact pads on the radiation receiving chip 910 with the corresponding contact pads on the processing chip 920.

FIG. 5 shows a pixel circuit 100 including a photoelectric conversion element 110 that converts incident radiation into a photoreceptor current IPC. A photoreceptor circuit 120 converts the photoreceptor current IPC into a photoreceptor voltage VPR in a conversion period, wherein an operating point of the photoreceptor circuit 120 is set in an initialization period in response to an active initialization signal INIT. An event detection circuit 150 outputs a digital event signal in response to a predefined change of the photoreceptor voltage VPR.

The photoelectric conversion element 110 may include or consist of a photodiode which by means of the photoelectric effect converts electromagnetic radiation incident on a detection surface of the pixel circuit 100 into a photodetector current IPC. The electromagnetic radiation may include visible light, infrared radiation and/or ultraviolet radiation. The amplitude of the photodetector current IPC corresponds to the intensity of the incident electromagnetic radiation, wherein in the intensity range of interest the photodetector current may increase approximately linearly with increasing intensity of the detected electromagnetic radiation.

The photoreceptor circuit 120 converts the photodetector current IPC into the photoreceptor voltage VPR in conversion periods. The voltage of the photoreceptor voltage VPR is a function of the photodetector current IPC, wherein in the voltage range of interest the voltage amplitude of the photoreceptor voltage VPR changes monotonically with continuously increasing photodetector current IPC. For example, the voltage amplitude of the photoreceptor voltage VPR continuously increases with continuously increasing photodetector current IPC or continuously decreases with continuously increasing photodetector current IPC.

The initialization signal INIT can be a digital signal changing between an active level and an inactive level. In the initialization period, the initialization signal INIT has the active level (active initialization signal) and switches the photoreceptor circuit 120 into an initialization mode. In the initialization mode, the photoreceptor circuit 120 adapts to an operating point for a following conversion period. The operating point can be adjusted to the instantaneous photodetector current IPC. In particular, the operating point can be set to be dependent from the instantaneous photodetector current IPC.

In the conversion period, the photoreceptor circuit 120 converts the photoreceptor current into the photoreceptor voltage VPR. The event detection circuit 150 compares a change of the photoreceptor voltage VPR or a voltage derived from the photoreceptor voltage VPR with a step-up threshold and a step-down threshold, and outputs event signals if the change of the photoreceptor voltage VPR exceeds one of the thresholds. Detection of an event and/or a further active initialization signal INIT may terminate the conversion period.

The initialization allows the photoreceptor circuit 120 to operate without feedback at high gain and with band-pass behavior in the conversion period. No feedback loop is required to adapt the operating point of the photoreceptor circuit 120 to the magnitude of the photoreceptor current for the conversion period. In combination with appropriate threshold voltages used in the event detection circuit 130, the high gain of the photoreceptor voltage VPR facilitates low latencies and/or better sensitivity.

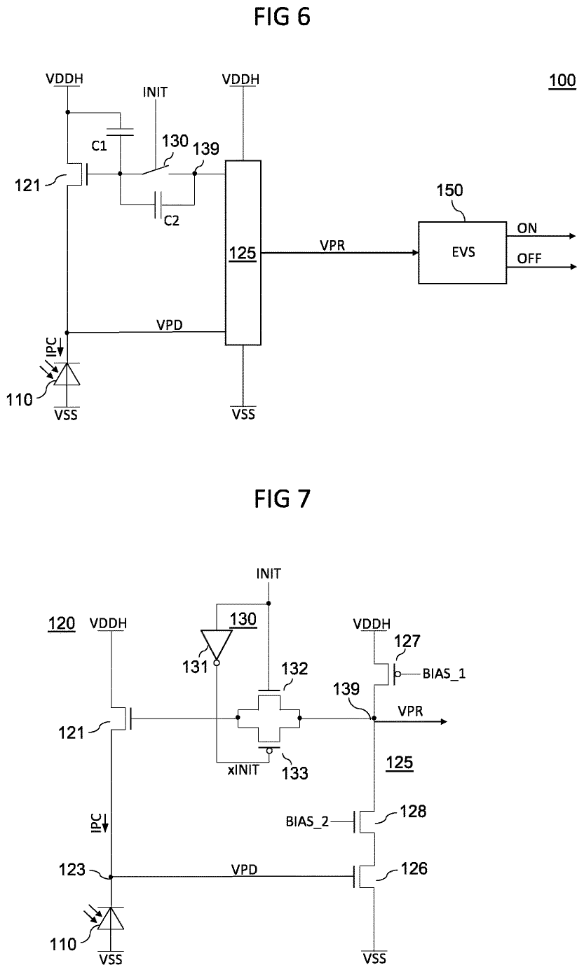

In FIG. 6, the photoreceptor circuit 120 includes a conversion transistor 121. The conversion transistor 121 and the photoelectric conversion element 110 are electrically connected in series between a positive pixel supply voltage VDDH and a reference potential VSS.

The conversion transistor 121 and the photoelectric conversion element 110 can be operated to realize an arbitrary transfer function, e.g., a linear transfer function. In embodiments described below, the conversion transistor 121 is configured to be operated in weak inversion in both the conversion periods and the initialization periods. When the conversion transistor 121 operates in weak inversion, the drain-to-source voltage of the conversion transistor 121 logarithmically increases with increasing photoreceptor current IPC.

The gate of the conversion transistor 121 may be configured to float in the conversion mode and to be connected to a non-floating node (139) in the initialization period.

The conversion transistor 121 may be a field effect transistor (FET), e.g., an n channel FET (nFET). In a photoreceptor circuit 120 based on non-ideal components, a first capacitance C1 is effective between the gate of the conversion transistor 121 and the positive pixel supply voltage VDDH, the reference potential VSS or another, different reference potential. A second capacitance C2 is effective between the gate of the conversion transistor 121 and the non-floating node 139. Each of the first and second capacitances C1, C2 may include exclusively parasitic capacitances, e.g., line capacitances and/or device capacitances. Each of the first and second capacitances C1, C2 may include explicit capacitive elements and/or structures provided in addition to the parasitic capacitances

In the initialization period, the second capacitance C2 is short-circuited and a potential at the gate of the conversion transistor 121 is set to a reset voltage defined by the potential at the non-floating node 139. In the conversion period, the potential at the gate of the conversion transistor 121 can be controlled by the potential of the non-floating node 139. By controlling the potential at the non-floating node 139, the conversion characteristic of the photoreceptor circuit 120 can be controlled. For example, the photoreceptor circuit 120 can be controlled to operate with a constant gain given by a ratio C2/C1 between the second capacitance C2 and the first capacitance C1.

The photoreceptor circuit 120 may further include an amplifier circuit 125 that amplifies a detector voltage VPD at a detector node 123 between the conversion transistor 121 and the photoelectric conversion element 110 into the photoreceptor voltage VPR. The non-floating node 139 is an internal network node of the amplifier circuit 125.

The photoelectric conversion element 110 may be directly electrically connected to the detector node 123. Alternatively, a further electronic device, e.g., a further transistor may be electrically connected in series between the detector node 123 and the photoelectric conversion element 110. The conversion transistor 121 may be directly electrically connected to the detector node 123. Alternatively, a further electronic device, e.g., a transistor may be electrically connected in series between the conversion transistor 121 and the detector node 123.

By initializing a voltage at the gate of the conversion transistor 121 with a voltage derived from the instantaneous photodetector current IPC, the operating points of the conversion transistor 121 and the photoreceptor circuit 120 can be precisely adjusted to the intensity of the instantaneous incident radiation.

In particular, the photoreceptor circuit 120 converts the instantaneous photoreceptor current IPC into the photoreceptor voltage VPR in both the initialization period and the conversion period. At the end of the initialization period, the operating point is set according to the instantaneous photodetector current and close to the conversion characteristic.

The event detection circuit 150 compares the photoreceptor voltage VPR with a step-up threshold and a step-down threshold and outputs an on-event signal ON or an off-event signal OFF accordingly.

The photoreceptor circuit 120 may further include a signal switching circuit 130 that connects a gate of the conversion transistor 121 to a non-floating node 139 in the initialization period and disconnects the gate of the conversion transistor 121 from the non-floating node 139 in the conversion period.

The gate of the conversion transistor 121 floats when the signal switching circuit 130 disconnects the gate of the conversion transistor 121 from the non-floating node in the conversion period.

The signal switching circuit 130 includes at least one FET and can be designed and/or operated to lower the effect of charge injection from the transistor channel of the FET into the drain side and/or source side when the FET is switched off. For example, a transition of an active initialization signal INIT switching on the FET to an inactive initialization signal switching off the FET may be slow enough that communication between the charge at the source side and the charge at the drain side is strong enough that at the end of the switching operation final voltages at both sides are equal.

FIG. 7 shows details of a photoreceptor circuit 120 that includes an amplifier circuit 125 and a signal switching circuit 130. The amplifier circuit 125 includes a load element 127, a cascode transistor 128 and an amplifier transistor 126 electrically connected in series between the positive pixel supply voltage VDDH and the reference potential VSS.

The photoreceptor circuit 120 can operate as logarithmic amplifier circuit (LAC) with the photoreceptor voltage VPR being a logarithmic function of the photoreceptor current IPC in the initialization period such that the operating points are set according to the high dynamic range of a logarithmic amplifier circuit. The logarithmic characteristic makes the output change ratio independent of the operating point.

For example, a change of a factor 2 in the input radiation always corresponds to the same absolute voltage difference in the photoreceptor voltage VPR, irrespective of the operating point.

The photoreceptor circuit 120 is initialized by setting the operation point for the conversion period in a closed feedback loop that provides a stabilizing effect. In the conversion period, the photoreceptor circuit 120 operates in open loop that provides high gain. The high gain in turns allows for low latency and/or better sensitivity.

The signal switching circuit 130 includes an nFET 132 and a pFET 133 electrically connected in parallel between the gate of the conversion transistor 121 and the non-floating node 139. The nFET 132 and the pFET 133 are configured to turn on in phase and turn off in phase.

For example, the signal switching circuit 130 may receive the initialization signal INIT and an inverted initialization signal xINIT from outside the pixel circuit 100, e.g., from the voltage/signal source circuit 20 or the sensor control circuit 50 illustrated in FIG. 2 or FIG. 3.

In the illustrated embodiment, the signal switching circuit 130 receives the initialization signal INIT and includes an inverter circuit 131 for obtaining the inverted initialization signal xINIT from the initialization signal INIT. The non-inverted initialization signal INIT is applied to the gate of the nFET 132. Simultaneously, the inverted initialization signal xINIT is applied to the gate of the pFET 133.

The nFET 132 and the pFET 133 form a complementary switch. The nFET 132 and the pFET 133 turn off simultaneously, with the nFET 132 injecting electrons and the pFET 133 injecting holes into the adjacent network nodes. The injected charges at least partially compensate for each other.

The amount of charge injection when the gate of the conversion transistor 121 is disconnected from the non-floating node 139 determines a settling time after which the photoreceptor voltage VPR can be correctly evaluated at the earliest. Since the complementary switch of FIG. 7 reduces the amount of charge injection, the complementary switch reduces the settling time and lowers latency.

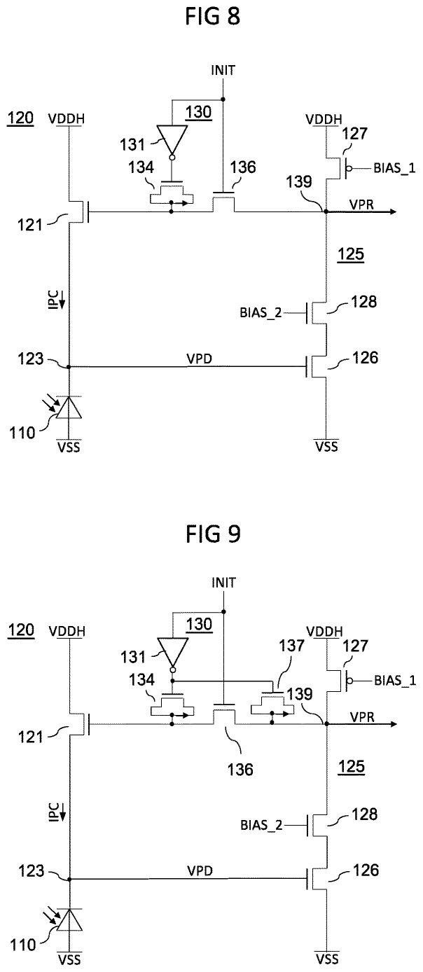

FIG. 8 shows a signal switching element 130 that includes an FET 136 and a dummy switch 134 electrically connected in series between the non-floating node 139 and the gate of the conversion transistor 121.

The dummy switch 134 has the structure of an FET with short-circuited source and drain. The short-circuited source and drain are electrically connected between the gate of the conversion transistor 121 and the FET 136 of the signal switching circuit 130. The dummy switch 134 and the FET 136 have the same channel type. In the illustrated example, the dummy switch 134 and the FET 136 have n channels.

The signal switching circuit 130 receives the initialization signal INIT and includes an inverter circuit 131 for obtaining the inverted initialization signal from the initialization signal INIT. The non-inverted initialization signal INIT is applied to the gate of the FET 136. Simultaneously, the inverted initialization signal is applied to the gate of the dummy switch 134. Channel charge deposited by the FET 136 during turn-off at the side oriented to the gate of the conversion transistor 121 is absorbed by the dummy switch 134 which simultaneously turns on and uses the absorbed charge for building up a transistor channel. A channel width of the dummy switch 134 may be in a range of 20% to 80%, e.g., about 40% to 60% of a channel width of the FET 136. For example, a channel width of the dummy switch 134 is about 50% of a channel width of the FET 136.

The dummy switch 134 reduces the amount of charge injection, reduces the settling time and lowers latency.

In FIG. 9 the signal switching element 130 includes an FET 136 and two dummy switches 134, 137 electrically connected in series between the non-floating node 139 and the gate of the conversion transistor 121, wherein the two dummy switches 134, 137 are on opposite sides of the FET 136. A first dummy switch 134 is connected between the gate of the conversion transistor 121 and the FET 136. A second dummy switch 137 is connected between the FET 136 and the non-floating node 139. In the illustrated example, the first and second dummy switches 137 and the FET 136 have n channels. A channel width of each dummy switch 134, 137 may be in a range of 20% to 80%, e.g., about 40% to 60% of a channel width of the FET 136. For example, a channel width of each of the first and second dummy switches 134, 137 is about 50% of a channel width of the FET 136.

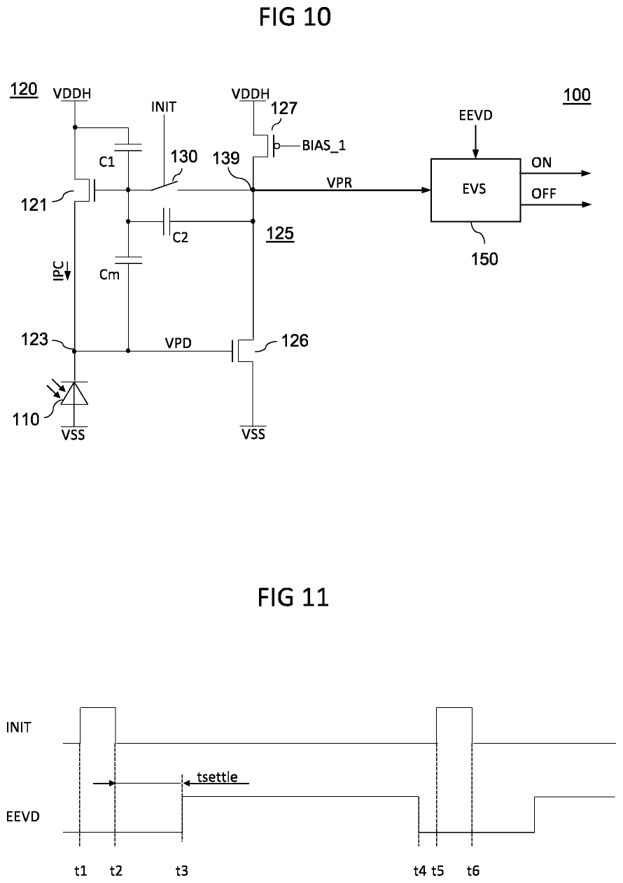

In FIG. 10 the amplifier circuit 125 is a common source amplifier circuit. The non-floating node 139 is a node in the output path of the common source amplifier circuit.

The amplifier circuit 125 includes a load element 127 and an amplifier transistor 126 electrically connected in series between the positive pixel supply voltage VDDH and the reference potential VSS. The detector node 123 is electrically connected to a gate of the amplifier transistor 126. The non-floating node 139 is between the load element 127 and the amplifier transistor 126.

A Miller capacitance Cm is effective between the input of the amplifier circuit 125 at the gate of the amplifier transistor 126 and the output node 139 of the amplifier circuit 125.

The amplifier circuit 125 outputs the photoreceptor voltage VPR at an output node between the load element 127 and the amplifier transistor 126. In the illustrated embodiment, the load element 127 is directly electrically connected to a load path of the amplifier transistor 126 and no further electronic switching element is electrically connected in series between the load element 127 and the amplifier transistor 126. The same network node provides both the output node and the non-floating node 139. The event detection circuit 150 receives an enable event detection signal EEVD. The enable event detection signal EEVD can be a digital signal changing between an active level and an inactive level. The event detection circuit 150 may receive the enable event detection signal EEVD from outside the pixel circuit 100, e.g., from the voltage/signal source circuit 20 or the sensor control circuit 50 illustrated in FIG. 2 or FIG. 3.

When the enable event detection signal EEVD is active, the event detection circuit 150 compares the photoreceptor voltage VPR with the step-up threshold and the step-down thresholds and outputs an on-event signal ON or an off-event signal OFF accordingly.

When the enable event detection signal EEVD is inactive, the event detection circuit 150 does not compare the photoreceptor voltage VPR with the step-up threshold and the step-down thresholds and/or does not output active event signals.

FIG. 11 shows the initialization signal INIT and the enable event detection signal EEVD with the digital high level representing the active level and the digital low level representing the inactive level.

The initialization signal INIT is active in a first initialization period between t=t1 and t=t2 and a second initialization period between t=t5 and t=t6. In a first conversion period between t=2 and t=t5, the enable event detection signal EEVD is set active at the earliest after expiration of the settling time tsettle. In a structured light application, the radiation source for emitting the structured light, e.g., a laser is active synchronously with the enable event detection signal EEVD. The laser may be swept over the imaged scene for the period between t=t3 and t=t4 with active enable event detection signal EEVD.

The initialization signal INIT and the enable event detection signal EEVD can be global signals applied to all pixel circuits 100 of a pixel array simultaneously. Alternatively, the initialization signal INIT and the enable event detection signal EEVD can applied to all pixel circuits 100 of a pixel row simultaneously, and sequentially to all pixel rows of a pixel array.

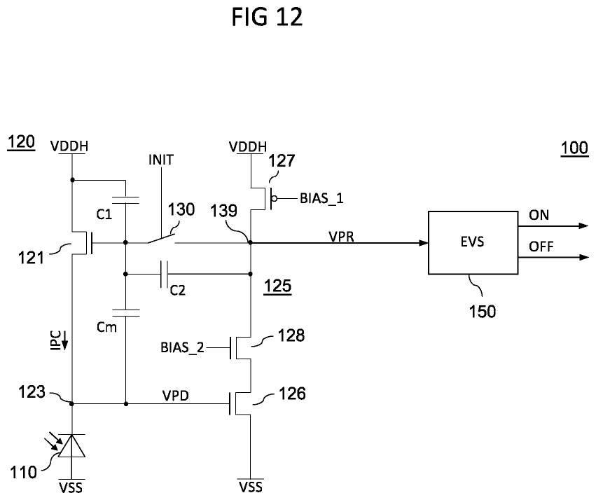

FIG. 12 shows a photoreceptor circuit 120 with the amplifier circuit 125 including a cascode transistor 128 electrically connected in series between the load element 127 and the amplifier transistor 126. In the illustrated embodiment, the non-floating node 139 is between the load element 127 and the cascode transistor 128.

The cascode transistor 128 may be an nFET with a constant second bias voltage BIAS_2 applied to the gate. The cascode transistor 128 can be used to reduce the effect of the Miller capacitance of the amplifier transistor 126 and improves the bandwidth of the amplifier circuit 125.

In an alternative operation mode of any of the photoreceptor circuits 120 as described above, the conversion transistor 121, the amplifier circuit 125 and a permanently closed signal switching circuit 130 can be permanently operated as a logarithmic amplifier circuit (LAC) for continuous event detection, wherein the event detection is only suspended by autozero periods for resetting a resettable voltage to a predefined voltage after each detected event.

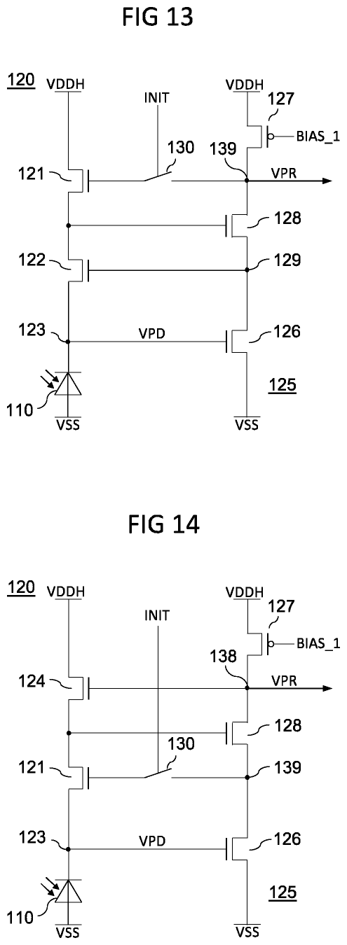

FIG. 13 and FIG. 13 show embodiments with improved gain for the initialization mode or the alternative operation mode for permanent event detection.

In FIG. 13, a first auxiliary conversion transistor 122 is electrically connected in series between the conversion transistor 121 and the photoelectric conversion element 110. A gate of the first auxiliary conversion transistor 122 receives a signal from a cascode node 129 of the amplifier circuit 130 between the cascode transistor 128 and the amplifier transistor 126. The non-floating node 139 is between the load element 127 and the cascode transistor 128. The non-floating node 139 forms also the output node at which the photoreceptor circuit 120 outputs the photoreceptor voltage VPR.

In particular, the conversion transistor 121, the first auxiliary conversion transistor 122, and the photoelectric conversion element 110 are electrically connected in series between the positive pixel supply voltage VDDH and the reference potential VSS in this order. The load element 127, the first cascode transistor 129, and the amplifier transistor 126 are electrically connected in series between the positive pixel supply voltage VDDH and the reference potential VSS in this order.

The detector node 123 between the first auxiliary conversion transistor 122 and the cathode of the photoelectric conversion element 110 is electrically coupled, for example, electrically connected directly to the gate of the amplifier transistor 126. The cascode node 129 between the cascode transistor 129 and the amplifier transistor 126 is electrically coupled, for example, electrically connected directly to the gate of the first auxiliary conversion transistor 122. A network node between the conversion transistor 121 and the first auxiliary conversion transistor 122 is electrically coupled, for example, electrically connected directly to the gate of the cascode transistor 128. The non-floating node 139 is between the load element 127 and the cascode transistor 128. The signal switching circuit 130 is in a signal path connecting the gate of the conversion transistor 121 and the non-floating node 139.

In FIG. 14, a second auxiliary conversion transistor 124 is electrically connected in series between the positive pixel supply voltage VDDH and the conversion transistor 121. A gate of the second auxiliary conversion transistor 124 receives a signal from an output node 138 of the amplifier circuit 125 between the load element 127 and the cascode transistor 128. The non-floating node 139 is between the cascode transistor 128 and the amplifier transistor 126.

In particular, the second auxiliary conversion transistor 124, the conversion transistor 121, and the photoelectric conversion element 110 are electrically connected in series between the positive pixel supply voltage VDDH and the reference potential VSS in this order. The load element 127, the cascode transistor 128, and the amplifier transistor 126 are electrically connected in series between the positive pixel supply voltage VDDH and the reference potential VSS in this order.

The detector node 123 between the conversion transistor 121 and the cathode of the photoelectric conversion element 110 is electrically coupled, for example, electrically connected directly to the gate of the amplifier transistor 126. The signal switching circuit 130 is in a signal path connecting the gate of the conversion transistor 121 and the non-floating node 139. The floating node 139 forms a cascode node between the cascode transistor 128 and the amplifier transistor 126. A network node between the second auxiliary conversion transistor 124 and the conversion transistor 121 is electrically coupled, for example, electrically connected directly to the gate of the cascode transistor 128. The output node 138 between the load element 127 and the cascode transistor 128 is electrically coupled, for example, electrically connected directly to the gate of the second auxiliary conversion transistor 124.

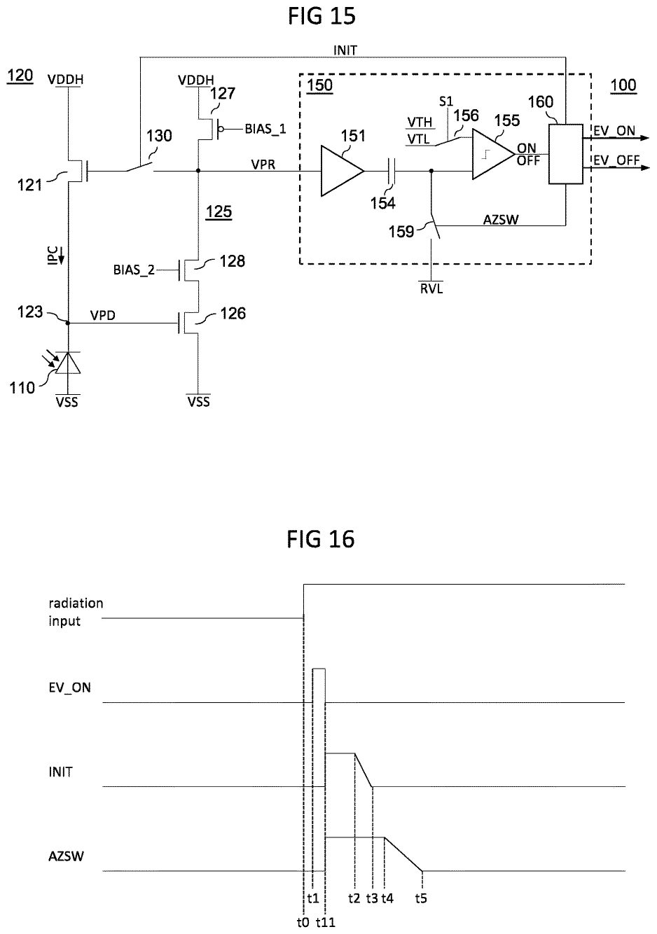

FIG. 15 shows an event detection circuit 150 that outputs an active event signal ON, OFF, when a change of the pixel voltage signal VPR exceeds a predefined threshold voltage for event detection.

A source follower circuit 151 receives the photoreceptor voltage VPR and outputs a source follower voltage VSF to charge a first electrode of a differencing capacitor 154. An autozero switch circuit 159 sets a potential at a second electrode of the differencing capacitor 154 to a predefined reference voltage level RVL in an autozero period. In a detection period following the autozero period, the second electrode of the differencing capacitor 154 floats and a potential VFN on the floating node tracks any change of the potential at the first electrode of the differencing capacitor 154. The floating node is electrically connected to a first input of a comparator circuit 155 that sequentially compares the potential VFP on the floating node with the step-up threshold VTH and the step-down threshold VTL sequentially applied to a second input of the comparator circuit 155 through a switching element 156.

The comparator circuit 155 outputs an active on-event signal ON, when an increase of the pixel voltage signal VPR exceeds the step-up threshold voltage VTH. The comparator circuit 155 outputs an active off-event signal OFF, when a decrease of the pixel voltage signal VPR exceeds the step-down threshold VTL.

Alternatively, the event detection circuit 150 includes a capacitive amplifier and two parallel comparator circuits, wherein the floating node is electrically connected to an input of the capacitive amplifier and the output of the capacitive amplifier is connected to first inputs of the two parallel comparator circuits that can simultaneously test for on-events and for off-events. Voltages applied to second inputs of the two parallel comparator circuits determine the step-up threshold VTH and the step-down threshold VTL. A feedback capacitor of the capacitive amplifier is electrically connected between the input and the output of an amplifying circuit. The autozero switch circuit is electrically connected in parallel to the feedback capacitor.

An in-pixel logic circuit 160 receives the on-event signal ON and the off-event signal OFF from the event detection circuit 150. The in-pixel logic circuit 160 may latch the active on-event signal ON and the active off-event signal OFF and controls data transfer of event data EV_ON, EV_ OFF through the data signal lines. Event data EV_ON obtained from the on-event signals ON and event data EV_OFF obtained from off-event signals OFF can be directly linked to motion and/or changing illumination conditions.

The in-pixel logic circuit 160 may output an autozero switch signal AZSW for controlling the autozero switch circuit 159 or may output an autozero control signal for routing an autozero switch signal AZSW to a control input of the autozero switch circuit 159.

The pixel circuit 100 may include a in-pixel logic circuit 160 that generates the initialization signal INIT.

The initialization signal INIT and the autozero switch signal AZSW may become active simultaneously such that the initialization period of the photoreceptor circuit 120 and the autozero period of the event detection circuit 150 begin at least approximately simultaneously.

The autozero switch signal AZSW may become inactive later than the initialization signal INIT such that the autozero period of the event detection circuit 150 ends only after the end of the initialization period to ensure proper settling of the charge injection effect in the photoreceptor circuit 120 and in the event detection circuit 150.

FIG. 16 shows the output signals of the in-pixel logic circuit 160 in response to an increase of incident radiation intensity at t=t0. In response to the increase in incident radiation, the in-pixel logic circuit 160 outputs an active request signal or an active on-event signal EV_ON indicating detection of an on-event at t=t1. The present embodiments shorten the response time between t=t0 and t=t1.

After readout of the event at t=t11, the in-pixel logic circuit 160 changes the initialization signal INIT and the autozero switch signal AZSW to the active level. At t=t2 the initialization signal INIT starts to change from the active level to the inactive level at a comparatively low rate to counter charge injection in the gate of the conversion transistor 121. The initialization period ends at t=t3 at the latest. At t=t4 the autozero switch signal AZSW starts to change from the active level to the inactive level at a comparatively low rate to counter charge injection in the floating node of the event detection circuit 150. The autozero period ends at t=t5 at the latest.

As discussed with reference to FIG. 4, an image sensor may include a radiation receiving chip 910 and a processing chip 920.

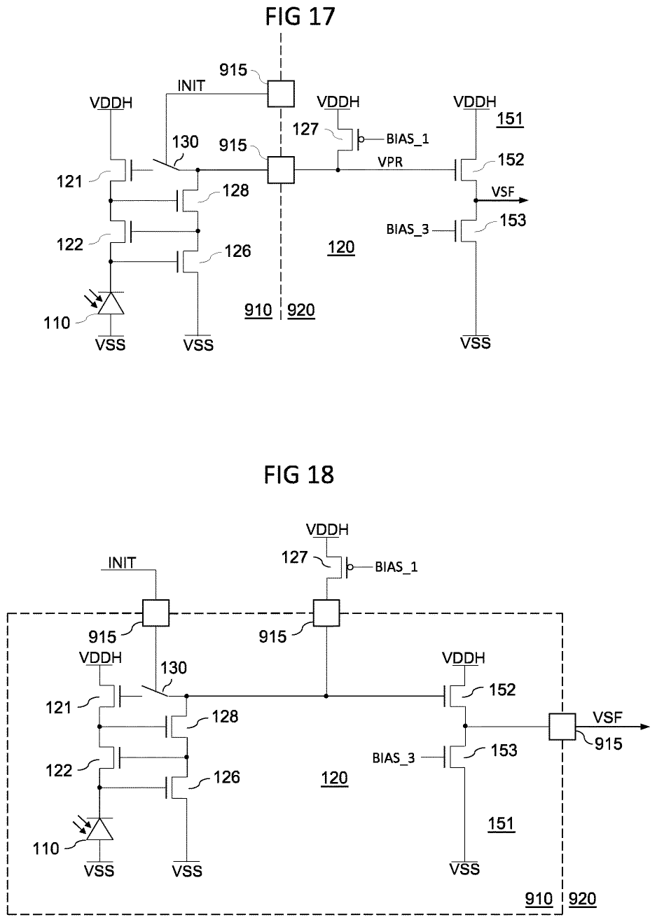

In FIG. 17, the radiation receiving chip 910 includes the photoelectric conversion element 110 and the nFETs 121, 122, 126, 128 of the photodetector circuit 120. The processing chip 920 includes a pull-up pFET used as the load element 127 of the common source amplifier circuit, the source follower 151 with a source follower amplifier nFET 152 and a source follower load nFET 153 receiving a constant third bias signal BIAS_3 at the gate, the event detection circuit and the in-pixel logic circuit. Two through contact vias 915 per pixel circuit pass the photodetector voltage VPR from the processing chip 920 to the radiation receiving chip 910 and the initialization signal INIT from the processing chip 920 to the radiation receiving chip 910.

In FIG. 18, the radiation receiving chip 910 includes the photoelectric conversion element 110, the nFETs 121, 122, 126, 128 of the photodetector circuit 120, and the source follower 151 with the source follower amplifier nFET 152 and the source follower load nFET 153. The processing chip 920 includes the pull-up pFET 127 used as the load element 127, the event detection circuit and the in-pixel logic circuit. A first through contact via 915 is part of an electric connection between the pull-p pFET 127 in the processing chip 920 and the output of the photodetector circuit 120 in the radiation receiving chip 910. A second through contact via 915 passes the source follower output signal VSF from the radiation receiving chip 910 to the processing chip 920. A third through contact via 915 passes the initialization signal INIT from the processing chip 920 to the radiation receiving chip 910.

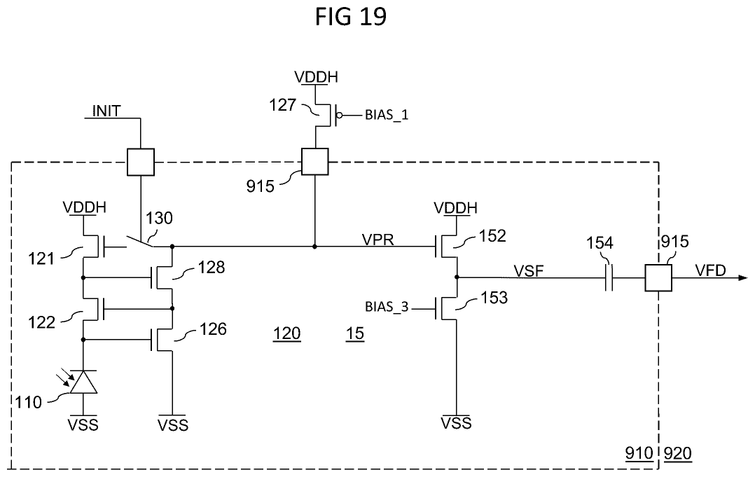

In FIG. 19, the radiation receiving chip 910 includes the photoelectric conversion element 110, the nFETs 121, 122, 126, 128 of the photodetector circuit 120, the source follower 151 with the source follower nFET 152 and the load nFET 153, and the differencing capacitor 154. The processing chip 920 includes the rest of the pixel circuit. A first through contact via 915 is part of an ohmic, low-resistive connection between the pull-p pFET 127 in the processing chip 920 and the output of the photoreceptor circuit 120 in the radiation receiving chip 910. A second through contact via 915 is part of a low-resistive, ohmic connection between the second electrode of the differencing capacitor 154 in the radiation receiving chip 910 and the first input of the comparator circuit 155 in the processing chip 920. A third through contact via 915 passes the initialization signal INIT from the processing chip 920 to the radiation receiving chip 910.

A solid-state imaging device 90 as illustrated in FIG. 2 and FIG. 3 includes pixel circuits 100. Each pixel circuit 100 includes a photoelectric conversion element 110, a photoreceptor circuit 120, and an event detection circuit 150. The photoelectric conversion element 110 is configured to convert incident radiation into a photoreceptor current IPC. The photoreceptor circuit 120 is configured to convert the photoreceptor current IPC into a photoreceptor voltage VPR in a conversion period, wherein an operating point of the photoreceptor circuit 120 is set in an initialization period in response to an active initialization signal INIT. The event detection circuit 150 is configured to output a digital event signal in response to a predefined change of the photoreceptor voltage VPR. The solid-state imaging device 90 further includes a sensor control circuit 50 configured to generate the active initialization signal INIT in response to an external signal. The external signal may be a signal indicating a laser scan for a structured light application. Control signal lines 21 may transmit the initialization signal INIT from the sensor control circuit 50 to the pixel circuits 100 globally or row-by-row.

The sensor control circuit 50 may further be configured to generate an enable event detection signal EEVD to turn on the event detection circuit 150, wherein the enable event detection signal EEVD becomes active in a conversion period following an initialization period. The enable event detection signal EEVD may become active after a settle time following the end of the initialization period. Control signal lines 21 may transmit the enable event detection signals EEVD from the sensor control circuit 50 to the pixel circuits 100 globally or row-by-row.

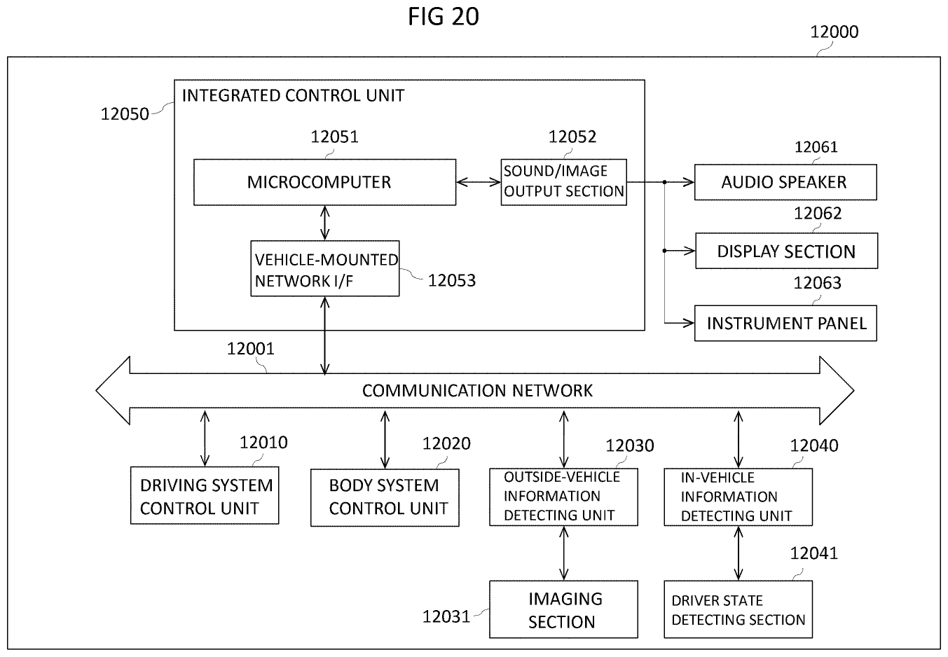

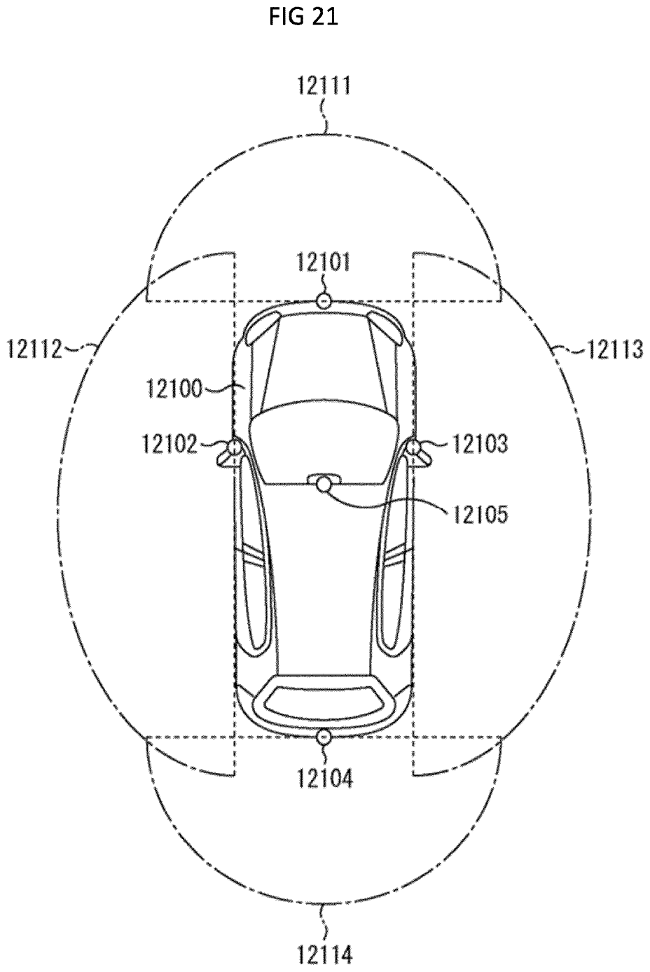

FIG. 20 is a block diagram depicting an example of schematic configuration of a vehicle control system as an example of a system to which the technology according to an embodiment of the present disclosure can be applied.

The vehicle control system 12000 includes a plurality of electronic control units connected to each other via a communication network 12001. In the example depicted in FIG. 20, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. The outside-vehicle information detecting unit 12030 can be connected with an imaging section 12031. The outside-vehicle information detecting unit 12030 makes the imaging section 12031 imaging an image of the outside of the vehicle and receives the imaged image. Based on the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 may be or may include a solid-state imaging device with an image sensor including pixel circuits according to the embodiments of the present disclosure. The light received by the imaging section 12031 may be visible light or may be invisible light such as infrared rays or the like.

The in-vehicle information detecting unit 12040 detects information about the inside of the vehicle and may be or may include an image sensor or a solid-state imaging device with an image sensor according to the embodiments of the present disclosure. The in-vehicle information detecting unit 12040 is, for example, connected with a driver state detecting section 12041 that detects the state of a driver. The driver state detecting section 12041, for example, includes a camera that includes the solid-stage imaging device and that is focused on the driver. Based on detection information input from the driver state detecting section 12041, the in-vehicle information detecting unit 12040 may calculate a degree of fatigue of the driver or a degree of concentration of the driver or may determine whether the driver is dozing.

The microcomputer 12051 can calculate a control target value for the driving force generating device, the steering mechanism, or the braking device based on the information about the inside or outside of the vehicle which information is obtained by the outside-vehicle information detecting unit 12030 or the in-vehicle information detecting unit 12040 and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automatic driving, which makes the vehicle to travel autonomously without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 based on the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound or an image to an output device capable of visually or audible notifying information to an occupant of the vehicle or the outside of the vehicle. In the example of FIG. 20, an audio speaker 12061, a display section 12062, and an instrument panel 12063 are illustrated as the output device. The display section 12062 may, for example, include at least one of an on-board display or a head-up display.

FIG. 21 is a diagram depicting an example of the installation position of the imaging section 12031, wherein the imaging section 12031 may include imaging sections 12101, 12102, 12103, 12104, and 12105.

The imaging sections 12101, 12102, 12103, 12104, and 12105 are, for example, disposed at positions on a front nose, side-view mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the side view mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 21 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the side view mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, imaging element having pixels for phase difference detection or may include a ToF module including an image sensor or a solid-state imaging device with an image sensor including pixel circuits according to the embodiments of the present disclosure.

For example, the microcomputer 12051 can determine a distance to each three-dimensional object within the imaging ranges 12111 to 12114 and a temporal change in the distance (relative speed with respect to the vehicle 12100 on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance and perform automatic brake control (including following stop control), automatic acceleration control (including following start control), or the like. It is thus possible to perform cooperative control intended for automatic driving that makes the vehicle travel autonomously without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062 and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

The example of the vehicle control system to which the technology according to an embodiment of the present disclosure is applicable has been described above. By applying an image sensor or a solid-state imaging device with an image sensor including pixel circuits according to the embodiments of the present disclosure, low latency and/or better sensitivity can be achieved.

Additionally, embodiments of the present technology are not limited to the above-described embodiments, but various changes can be made within the scope of the present technology without departing from the gist of the present technology.

The image sensor with pixel circuits according to the present disclosure may be any device used for analyzing and/or processing radiation such as visible light, infrared light, ultraviolet light, and X-rays. For example, a solid-state imaging device including an image sensor with pixel circuits according to the embodiments may be any electronic device in the field of traffic, the field of home appliances, the field of medical and healthcare, the field of security, the field of beauty, the field of sports, the field of agriculture, the field of image reproduction or the like.

Specifically, in the field of image reproduction, the solid-state imaging device including an image sensor with pixel circuits according to the embodiments may be a device for capturing an image to be provided for appreciation, such as a digital camera, a smart phone, or a mobile phone device having a camera function. In the field of traffic, for example, the solid-state imaging device including an image sensor with pixel circuits according to the embodiments may be integrated in an in-vehicle sensor that captures the front, rear, peripheries, an interior of the vehicle, etc. for safe driving such as automatic stop, recognition of a state of a driver, or the like, in a monitoring camera that monitors traveling vehicles and roads, or in a distance measuring sensor that measures a distance between vehicles or the like.

In the field of home appliances, the image sensor with pixel circuits according to the embodiments may be integrated in any type of sensor that can be used in devices provided for home appliances such as TV receivers, refrigerators, and air conditioners to capture gestures of users and perform device operations according to the gestures. Accordingly, the image sensor with pixel circuits according to the embodiments may be integrated in home appliances such as TV receivers, refrigerators, and air conditioners and/or in devices controlling the home appliances. Furthermore, in the field of medical and healthcare, the image sensor with pixel circuits according to the embodiments may be integrated in any type of sensor, e.g., a solid-state image device, provided for use in medical and healthcare, such as an endoscope or a device that performs angiography by receiving infrared light.

In the field of security, the image sensor with pixel circuits according to the embodiments can be integrated in a device provided for use in security, such as a monitoring camera for crime prevention or a camera for person authentication use. Furthermore, in the field of beauty, an image sensor with pixel circuits according to the embodiments can be used in a device provided for use in beauty, such as a skin measuring instrument that captures skin or a microscope that captures a probe. In the field of sports, an image sensor with pixel circuits according to the embodiments can be integrated in a device provided for use in sports, such as an action camera or a wearable camera for sport use or the like. Furthermore, in the field of agriculture, the image sensor with pixel circuits can be used in a device provided for use in agriculture, such as a camera for monitoring the condition of fields and crops.

The present technology can also be configured as described below:
[1] A pixel circuit (100) includes a photoelectric conversion element (110) configured to convert incident radiation into a photoreceptor current IPC; a photoreceptor circuit (120) configured to convert the photoreceptor current IPC into a photoreceptor voltage VPR in a conversion period, wherein an operating point of the photoreceptor circuit (120) is set in an initialization period in response to an active initialization signal INIT; and an event detection circuit (150) configured to output a digital event signal in response to a predefined change of the photoreceptor voltage VPR.
[2] The pixel circuit according to [1], further including wherein the photoreceptor circuit (120) includes a conversion transistor (121), wherein the conversion transistor (121) and the photoelectric conversion element (110) are electrically connected in series between a positive pixel supply voltage VDDH and a reference potential VSS.
[3] The pixel circuit according to [2], wherein a gate of the conversion transistor (121) is configured to float in the conversion mode and to be connected to a non-floating node (139) in the initialization period.
[4] The pixel circuit according to [3], wherein the photoreceptor circuit (120) includes an amplifier circuit (125) configured to amplify a detector voltage VPD at a detector node (123) between the conversion transistor (121) and the photoelectric conversion element (110) into the photoreceptor voltage VPR, and wherein the non-floating node (139) is an internal network node of the amplifier circuit (125).
[5] The pixel circuit according to any of [3] and [4], further including a signal switching circuit (130) configured to connect a gate of the conversion transistor (121) to the non-floating node (139) in the initialization period and disconnect the gate of the conversion transistor (121) from the non-floating node (139) in the conversion period.
[6] The pixel circuit according to [5], wherein the signal switching circuit (130) includes an nFET (132) and a pFET (133) electrically connected in parallel between the gate of the conversion transistor (121) and the non-floating node (139), and wherein the nFET (132) and the pFET (133) are configured to turn on and turn off in phase.
[7] The pixel circuit according to any of [5] or [6], wherein the signal switching element (130) includes a FET (136c) and a dummy switch (134) electrically connected in series between the non-floating node (139) and the gate of the conversion transistor (121).
[8] The pixel circuit according to any of [4] to [7], wherein the amplifier circuit (125) is a common source amplifier circuit.
[9] The pixel circuit according to any of [4] to [8], wherein the amplifier circuit (125) includes at least a load element (127) and an amplifier transistor (126) electrically connected in series between the positive pixel supply voltage VDDH and the reference potential VSS, wherein the detector node (123) is electrically connected to a gate of the amplifier transistor (126), and wherein the non-floating node (139) is between the load element (127) and the amplifier transistor (126).
[10] The pixel circuit according to [9], wherein the amplifier circuit (125) further includes a cascode transistor (128) electrically connected in series between the load element (127) and the amplifier transistor (126), and wherein the non-floating node (139) is between the load element (127) and the cascode transistor (128).
[11] The pixel circuit according to [10], further including: a first auxiliary conversion transistor (122) electrically connected in series between the conversion transistor (121) and the photoelectric conversion element (110), wherein a gate of the first auxiliary conversion transistor (122) is configured to receive a signal from a cascode node (129) of the amplifier circuit (130) between the cascode transistor (128) and the amplifier transistor (126), and wherein the non-floating node (139) is between the load element (127) and the cascode transistor (128).
[12] The pixel circuit according to [10], further including: a second auxiliary conversion transistor (124) electrically connected in series between the positive pixel supply voltage VDDH and the conversion transistor (1212), wherein a gate of the second auxiliary conversion transistor (124) is configured to receive a signal from an output node (138) of the amplifier circuit (125) between the load element (127) and the cascode transistor (128), and wherein the non-floating node (139) is between the cascode transistor (128) and the amplifier transistor (126).
[13] The pixel circuit according to any of [1] to [12], wherein the event detection circuit (150) includes a logic circuit (156) configured to generate the initialization signal INIT.
[14] A solid-state imaging device (90), including: pixel circuits (100) wherein each pixel circuit (100) includes: a photoelectric conversion element (110) configured to convert incident radiation into a photoreceptor current IPC, a photoreceptor circuit (120) configured to convert the photoreceptor current IPC into a photoreceptor voltage VPR in a conversion period, wherein an operating point of the photoreceptor circuit (120) is set in an initialization period in response to an active initialization signal INIT, and an event detection circuit (150) configured to output a digital event signal in response to a predefined change of the photoreceptor voltage VPR; and a sensor controller circuit (50) configured to generate an active initialization signal INIT in response to an external signal.
[15] The solid-state imaging device according to [14], wherein the sensor controller circuit (50) is further configured to generate an enable event detection signal EEVD to turn on the event detection circuit (150), wherein the enable event detection signal becomes active in a conversion period following an initialization period.

1. A pixel circuit, comprising:
a photoelectric conversion element configured to convert incident radiation into a photoreceptor current IPC;
a photoreceptor circuit configured to convert the photoreceptor current IPC into a photoreceptor voltage VPR in a conversion period, wherein an operating point of the photoreceptor circuit is set in an initialization period in response to an active initialization signal INIT; and
an event detection circuit configured to output a digital event signal in response to a predefined change of the photoreceptor voltage VPR.

2. The pixel circuit according to claim 1,
wherein the photoreceptor circuit comprises a conversion transistor, wherein the conversion transistor and the photoelectric conversion element are electrically connected in series between a positive pixel supply voltage VDDH and a reference potential VSS.

3. The pixel circuit according to claim 2,
wherein a gate of the conversion transistor is configured to float in the conversion mode and to be connected to a non-floating node in the initialization period.

4. The pixel circuit according to claim 3,
wherein the photoreceptor circuit comprises an amplifier circuit configured to amplify a detector voltage VPD at a detector node between the conversion transistor and the photoelectric conversion element into the photoreceptor voltage VPR, and wherein the non-floating node is an internal network node of the amplifier circuit.

5. The pixel circuit according to claim 3, further comprising
a signal switching circuit configured to connect a gate of the conversion transistor to the non-floating node in the initialization period and disconnect the gate of the conversion transistor from the non-floating node in the conversion period.

6. The pixel circuit according to claim 5,
wherein the signal switching circuit comprises an nFET and a pFET electrically connected in parallel between the gate of the conversion transistor and the non-floating node, and wherein the nFET and the pFET are configured to turn on and turn off in phase.

7. The pixel circuit according to claim 5,
wherein the signal switching element comprises a FET and a dummy switch electrically connected in series between the non-floating node and the gate of the conversion transistor.

8. The pixel circuit according to claim 4,
wherein the amplifier circuit is a common source amplifier circuit.

9. The pixel circuit according to claim 4,
wherein the amplifier circuit comprises at least a load element and an amplifier transistor electrically connected in series between the positive pixel supply voltage VDDH and the reference potential VSS, wherein the detector node is electrically connected to a gate of the amplifier transistor, and wherein the non-floating node is between the load element and the amplifier transistor.

10. The pixel circuit according to claim 9,
wherein the amplifier circuit further comprises a cascode transistor electrically connected in series between the load element and the amplifier transistor, and wherein the non-floating node is between the load element and the cascode transistor.

11. The pixel circuit according to claim 10, further comprising:
a first auxiliary conversion transistor electrically connected in series between the conversion transistor and the photoelectric conversion element, wherein a gate of the first auxiliary conversion transistor is configured to receive a signal from a cascode node of the amplifier circuit between the cascode transistor and the amplifier transistor, and wherein the non-floating node is between the load element and the cascode transistor.

12. The pixel circuit according to claim 10, further comprising:
a second auxiliary conversion transistor electrically connected in series between the positive pixel supply voltage VDDH and the conversion transistor, wherein a gate of the second auxiliary conversion transistor is configured to receive a signal from an output node of the amplifier circuit between the load element and the cascode transistor, and wherein the non-floating node is between the cascode transistor and the amplifier transistor.

13. The pixel circuit according to claim 1,
wherein the event detection circuit comprises a logic circuit configured to generate the initialization signal INIT.

14. A solid-state imaging device, comprising:
pixel circuits wherein each pixel circuit comprises:
a photoelectric conversion element configured to convert incident radiation into a photoreceptor current IPC,
a photoreceptor circuit configured to convert the photoreceptor current IPC into a photoreceptor voltage VPR in a conversion period, wherein an operating point of the photoreceptor circuit is set in an initialization period in response to an active initialization signal INIT, and
an event detection circuit configured to output a digital event signal in response to a predefined change of the photoreceptor voltage VPR; and
a sensor control circuit configured to generate an active initialization signal INIT in response to an external signal.

15. The solid-state imaging device according to claim 14,
wherein the sensor control circuit is further configured to generate an enable event detection signal EEVD to turn on the event detection circuit, wherein the enable event detection signal becomes active in a conversion period following an initialization period.
